(19) United States
(12) Patent Application Publication
(10) Pub. No.: US 2015/0339685 A1
(43) Pub. Date: Nov. 26, 2015

(54) METHOD AND SYSTEM FOR IDENTIFYING INFLUENCERS IN NOMADIC SUBCULTURES

(71) Applicant: MasterCard International Incorporated, Purchase, NY (US)

(72) Inventors: Kenneth UNSER, Fairfield, CT (US); Nikhil MALGATTI, Stamford, CT (US); Serge BERNARD, Danbury, CT (US)

(73) Assignee: MasterCard International Incorporated, Purchase, NY (US)

(21) Appl. No.: 14/282,390

(22) Filed: May 20, 2014

(51) Int. Cl. G06Q 30/02

(52) U.S. Cl. CPC G06Q 30/0204; G06Q 30/0205

(57) ABSTRACT

A method for identifying influencers in nomadic subcultures includes: storing a plurality of transaction data entries, each including data related to a payment transaction including a plurality of merchant data values, a consumer identifier, and a plurality of transaction data values; storing a plurality of consumer profiles, each including data related to a consumer including a consumer identifier and consumer data; identifying merchant data values and transaction data values associated with a nomadic subculture; identifying a subset of transaction data entries where the merchant data values and transaction data values includes at least one of the merchant data values and transaction data values associated with the nomadic subculture; identifying one or more consumer identifiers included in at least two transaction data entries in the subset; and identifying a consumer profile including a consumer identifier of the identified one or more consumer identifiers.

### FIELD

The present disclosure relates to the identification of influencers in nomadic subcultures, specifically the use of transaction and event data to identify consumers in nomadic subcultures and to identify influencers among the consumers based on frequency.

### BACKGROUND

In societies with large populations, people often separate themselves based on common interest, hobbies, and other things into smaller groups, or subcultures. A person may be a part of any number of subcultures at the same time, and may participate in any one of the subcultures as much or as little as they wish. In some instances, these subcultures may be nomadic subcultures, and may travel from location to location to participate in events based on their subculture. For example, a subculture associated with a band may follow the band from city to city on a tour, a marathon subculture may go from city to city where races are being held, a skiing subculture may go from resort to resort during the ski season, etc.

Advertisers, deal providers, merchants, and other entities may be interested in identifying members of subcultures. For instance, members of subcultures may be ideal targets for certain types of advertising. In an example, an electronics manufacturer may wish to advertise to consumers who are in a subculture that regularly attends consumer electronics conventions. In some cases, it may be even more preferable for an advertiser or merchant to target an influential member of a subculture. For example, a merchant with a new product may want to provide free samples of the new product to influential members of a subculture, in the hopes that it will entice other members to purchase or try the product.

However, there is currently a lack of suitable methods for identifying members of a subculture, let alone a subculture's influencers. Current methods for identifying subculture members include reviewing attendance information for events, such as attendee name listings or ticket purchasing information. However, in many instances, events for a subculture may not attain any information suitable for identifying the attendees. For example, concerts, ski resorts, barbecue competitions, craft fairs, and other types of subculture events may sell tickets or have free attendance, without any identification of the attendees. In addition, in instances where attendees may be identified, such as by a list of names from registration of an event, it may require significant time and resources to obtain lists from each event of a subculture, which may be managed and/or operated by different entities, and to analyze each of these lists to identify influencers.

Thus, there is a need for a technical solution to provide a more efficient, and more effective, method for identifying influencers in a nomadic subculture.

### SUMMARY

The present disclosure provides a description of systems and methods for the identifying of influencers in nomadic subcultures.

A method for identifying influencers in nomadic subcultures includes: storing, in a transaction database, a plurality of transaction data entries, wherein each transaction data entry includes data related to a payment transaction including at least a plurality of merchant data values associated with a merchant involved in the related payment transaction, a consumer identifier associated with a consumer involved in the related payment transaction, and a plurality of transaction data values; storing, in a consumer database, a plurality of consumer profiles, wherein each consumer profile includes data related to a consumer including at least a consumer identifier associated with the related consumer and consumer data; identifying, by a processing device, one or more merchant data values and one or more transaction data values associated with a nomadic subculture; identifying, in the transaction database, a subset of the plurality of transaction data entries where the plurality of merchant data values includes at least one of the identified one or more merchant data values and at least one of the plurality of transaction data values includes the identified one or more transaction data values in each transaction data entry included in the subset; identifying, in the subset of the plurality of transaction data entries, one or more consumer identifiers included in at least two transaction data entries in the subset of transaction data entries; and identifying, in the consumer database, at least one consumer profile including a consumer identifier of the identified one or more consumer identifiers.

A system for identifying influencers in nomadic subcultures includes a transaction database, a consumer database, and a processing device. The transaction database is configured to store a plurality of transaction data entries, wherein each transaction data entry includes data related to a payment transaction including at least a plurality of merchant data values associated with a merchant involved in the related payment transaction, a consumer identifier associated with a consumer involved in the related payment transaction, and a plurality of transaction data values. The consumer database is configured to store a plurality of consumer profiles, wherein each consumer profile includes data related to a consumer including at least a consumer identifier associated with the related consumer and consumer data. The processing device is configured to: identify one or more merchant data values and one or more transaction data values associated with a nomadic subculture; identify, in the transaction database, a subset of the plurality of transaction data entries where the plurality of merchant data values includes at least one of the identified one or more merchant data values and at least one of the plurality of transaction data values includes the identified one or more transaction data values in each transaction data entry included in the subset; identify, in the subset of the plurality of transaction data entries, one or more consumer identifiers included in at least two transaction data entries in the subset of transaction data entries; and identify, in the consumer database, at least one consumer profile including a consumer identifier of the identified one or more consumer identifiers.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying influencers in nomadic subcultures in accordance with exemplary embodiments.

FIG. 2 is a block diagram illustrating the removable computing device of FIG. 1 for identifying influencers in nomadic subcultures in accordance with exemplary embodiments.

FIG. 3 is a flow diagram illustrating a method for the identification of influencers in a nomadic subculture in accordance with exemplary embodiments.

FIG. 4 is a flow chart illustrating an exemplary method for identifying influencers in nomadic subcultures in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal , etc. Use of the term “payment network” herein may refer to both the payment network as an entity, and the physical payment network, such as the equipment, hardware, and software comprising the payment network.

### System for Identifying Influencers in Nomadic Subcultures

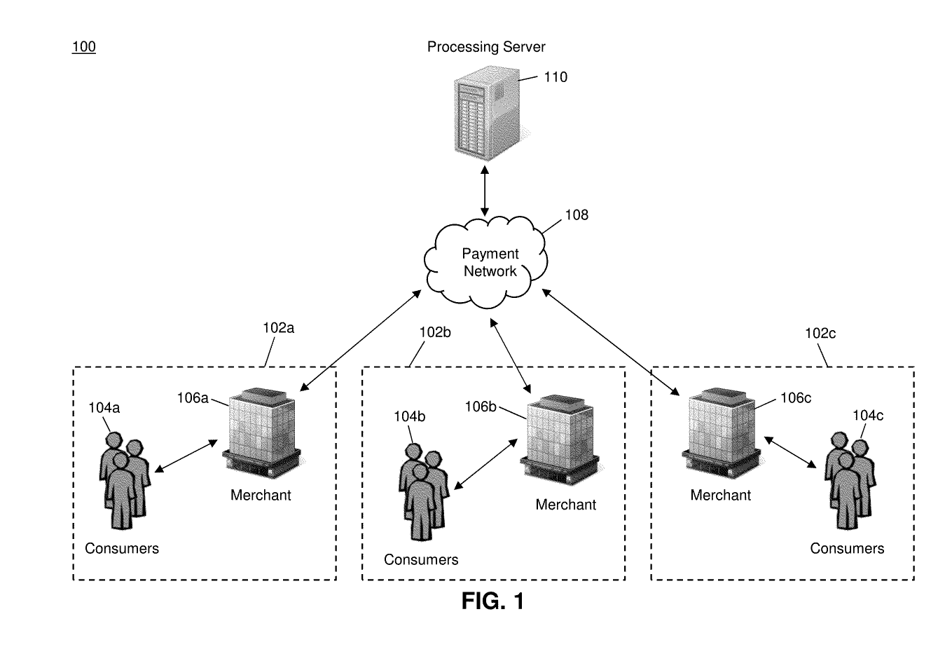

FIG. 1 illustrates a system 100 for the identification of influencers in nomadic subcultures using transaction data.

The system 100 may include a processing server 110. The processing server 110, discussed in more detail below, may be configured to identify influencers in nomadic subcultures based on transaction data. The transaction data may be obtained from a payment network 108, which may be configured to process payment transactions using methods or systems that will be apparent to persons having skill in the relevant art. In some embodiments, the processing server 110 may be a part of the payment network 108, and may also be further configured to process payment transactions.

The payment network 108 may be configured to process transactions involving consumers 104 in nomadic subcultures. As discussed in more detail below, the payment network 108 and/or the processing server 110 may identify transactions as being indicative of a nomadic subculture based on transaction data and/or merchant data. For example, in the embodiment illustrated in FIG. 1, events may be held associated with a nomadic subculture, such as conventions. Each event may have an associated geographic area 102, illustrated in FIG. 1 as areas 102a, 102b, and 102c, associated with three different nomadic subculture events, respectively. In some embodiments, each event may also have additional criteria, such as a specific location and date and/or time, such as a range of dates when a convention is being held.

Consumers 104 in the nomadic subculture may conduct payment transactions involving merchants 106 in each geographic area 102, as illustrated in FIG. 1. The payment transactions may be processed by the payment network 108, and corresponding transaction data transmitted to the processing server 110. The payment network 108 and/or processing server 110 may identify the transactions as being associated with a consumer 104 in a nomadic subculture based on identifying data, such as the geographic location 102 of the transaction and additional criteria (e.g., time, date, merchant name, merchant type, product name, product type, etc.).

The processing server 110 may then identify consumer profiles of consumers 104 that are associated with the payment transactions that are identified as being associated with a consumer in a nomadic subculture. The processing server 110 may then identify consumer profiles that are related to consumers 104 that have attended more of the nomadic subculture events than other consumers 104 in the subculture. For example, the processing server 110 may identify a discrete number of consumers 104 (e.g., the top 3) or a percentage of consumers 104 (e.g., the top 1%) based on a number of subculture events attended, as evidence by the associated transaction data.

By using transaction data to identify consumers in a nomadic subculture, the processing server 110 may identify consumers more efficiently and more effectively than traditional methods. In addition, identifying consumers via transaction data may preserve consumer privacy, as consumers may be identified without payment account numbers or other information that may be personally identifiable to the consumer 104. Furthermore, as the processing server 110 may be able to identify a number of events attended by each consumer 104, the processing server 110 may more easily identify influencers based on attendance. In some embodiments, the processing server 110 may also use additional criteria to identify influencers, such as based on spending associated with the nomadic subculture events. For example, the processing server 110 may analyze the transaction data to identify consumers 104 that spend more than other consumers, or that purchase items or visit merchants 106 before other consumers 104 in the subculture.

### Processing Server

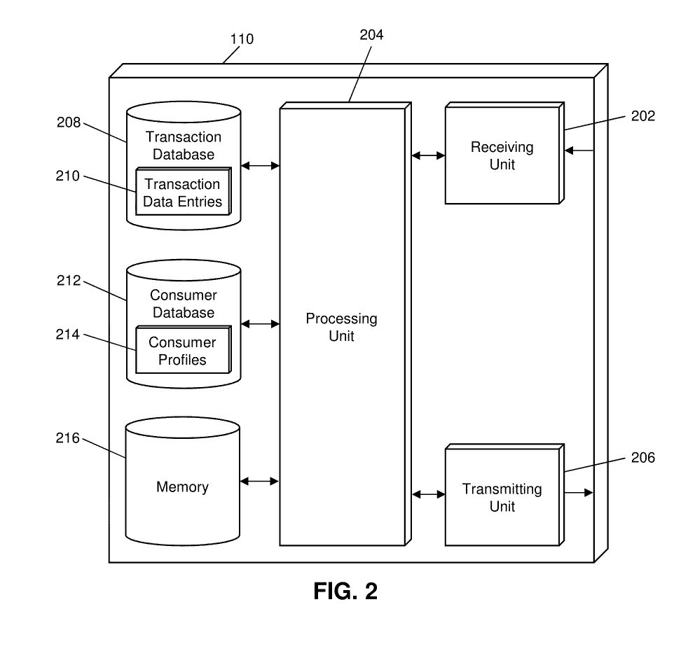

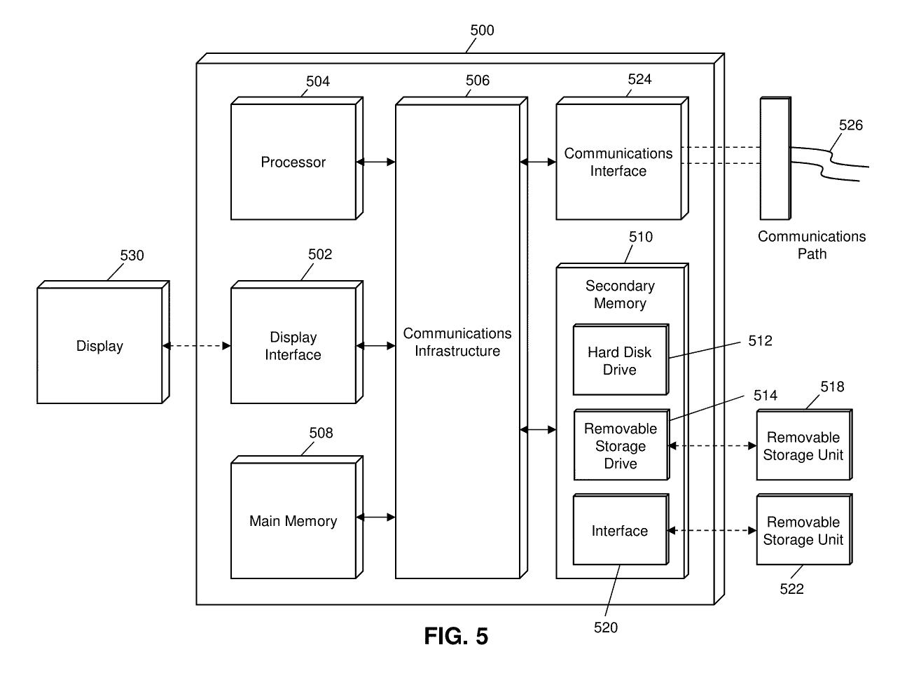

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of processing server 110 suitable for performing the functions as discussed herein. For example, the computer system 500 illustrated in FIG. 5 and discussed in more detail below may be a suitable configuration of the processing server 110.

The processing server 110 may include a receiving unit 202. The receiving unit 202 may be configured to receive data over one or more networks via one or more network protocols. The receiving unit 202 may receive transaction data from the payment network 108. The processing server 110 may also include a processing unit 204. The processing unit 204 may be configured to store the received transaction data in a transaction database 208 as a plurality of transaction data entries 210.

Each transaction data entry 210 may include data related to a payment transaction and may include at least a plurality of merchant data values, a plurality of transaction data values, and a consumer identifier. The plurality of merchant data values may include data associated with a merchant 106 involved in the related payment transaction, such as a name, category, identification number, geographic location, etc. The transaction data values may include additional data associated with the transaction, such as a geographic location, transaction amount, time and/or date, product data, coupon data, etc. The consumer identifier may be an identification value associated with a consumer 104 involved in the related payment transaction.

The processing server 110 may also include a consumer database 212. The consumer database 212 may include a plurality of consumer profiles 214. Each consumer profile 214 may include data related to a consumer 104 including at least a consumer identifier associated with the related consumer and consumer data. The consumer identifier may be a unique value suitable for identification of the consumer profile 214, such as a payment account number, name, username, e-mail address, telephone number, identification number, etc. The consumer data may be any additional data associated with the consumer 104 that may be suitable for performing the functions disclosed herein. For example, the consumer data may include a home geographic location, which may be used to identify if the related consumer 104 travels for subculture events.

The receiving unit 202 may be further configured to receive data regarding nomadic subculture events. The data may include one or more merchant data values and one or more transaction data values associated with the nomadic subculture and/or one or more specific events associated with the nomadic subculture. For example, the one or more merchant data values may include a geographic location associated with an event, and the one or more transaction data values may include a period of time associated with the event. In some cases, the data values may be associated with multiple events. In some embodiments, the data may be received from an input unit, which may also be included in the processing server 110. The input unit may be a keyboard, mouse, click wheel, touch screen, microphone, camera, or other suitable input device as will be apparent to persons having skill in the relevant art.

In some embodiments, data regarding nomadic subculture events may be identified by the processing unit 204. In such an embodiment, the processing unit 204 may be configured to identify one or more merchant data values and one or more transaction data values associated with a nomadic subculture. For instance, to identify events associated with a skiing subculture, the processing unit 204 may identify merchant data values associated with ski resorts, such as corresponding merchant names, merchant category codes, etc.

The processing unit 204 may be configured to identify transaction data entries 210 stored in the transaction database 208 based on the received nomadic subculture data, where the included plurality of merchant data values includes at least one of the received one or more merchant data values and where the included plurality of transaction data values includes at least one of the received one or more transaction data values. The processing unit 204 may then identify one or more consumer identifiers included in the identified transaction data entries 210 that are included in two or more transaction data entries 210, which may indicate that the related consumer 104 was involved in multiple nomadic subculture events.

The processing unit 204 may then be configured to identify the consumer profiles 214 in the consumer database 212 that include the identified consumer identifiers, and may update the consumer profiles 214 to indicate the attended events. In some embodiments, the processing unit 204 may be further configured to identify one or more influencers based on the number of attended events. In a further embodiment, the processing unit 204 may identify a predetermined number of influencers or may identify influencers as consumers 104 who attended a predetermined number of events. In some embodiments, influencers may also be identified based on additional criteria, such as based on the transaction data values included in the transaction data entries 210 related to payment transactions involving the related consumer 104.

In some embodiments, the receiving unit 202 may be configured to receive a request for influencers, such as from a third party merchant or advertiser. The request for influencers may include the one or more merchant and transaction data values suitable for the identification of influencers in the associated nomadic subculture. In such an embodiment, the processing server 110 may include a transmitting unit 206 that may be configured to transmit data over one or more networks via one or more network protocols. The transmitting unit 206 may transmit the identified influencers in response to the received request for influencers.

The processing server 110 may also include a memory 216. The memory 216 may be configured to store data suitable for performing the functions as disclosed herein. For example, the memory 216 may store algorithms and/or functions suitable for identifying an influencer among consumers 104 in a nomadic subculture based on a number of attended events and spending data included in corresponding transaction data, may store predetermined numbers and/or other criteria for identifying a consumer 104 as an influencer, etc. Additional data that may be stored in the memory 216 will be apparent to persons having skill in the relevant art.

### Process for Identifying Influencers in a Nomadic Subculture

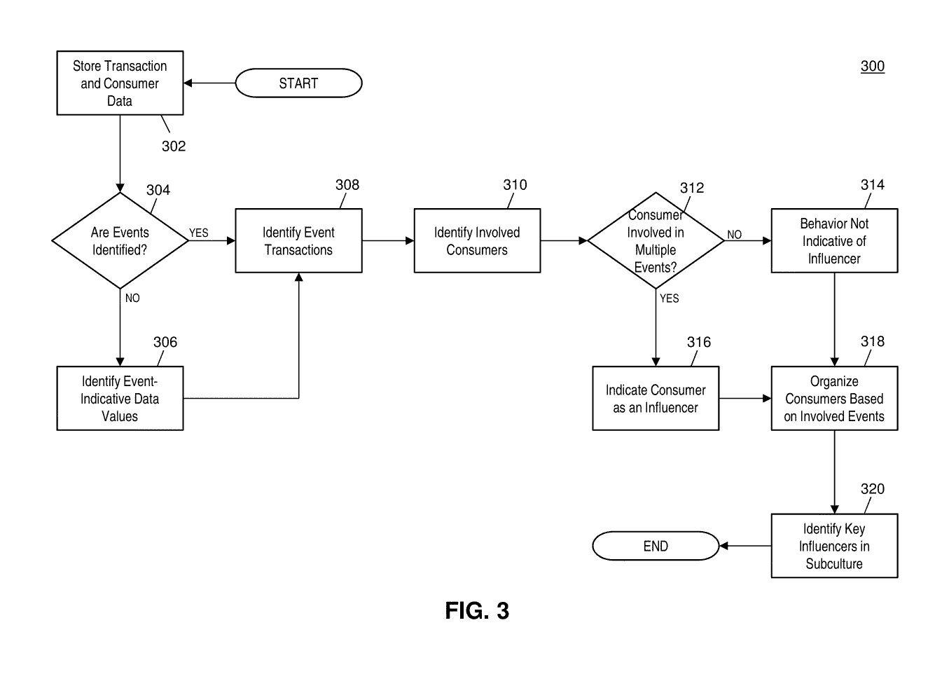

FIG. 3 illustrates a process 300 for the identification of influencers in a nomadic subculture using transaction data.

In step 302, the processing unit 204 of the processing server 110 may receive and store transaction data and consumer data in the transaction database 208 and consumer database 212, respectively. In step 304, the processing unit 204 may determine if any events have been identified, which may include determining if the receiving unit 202 has received merchant data values and transaction data values suitable for the identification of event-related payment transactions. If events have not been identified, then, in step 306, the processing unit 204 may identify one or more merchant data values and one or more transaction data values indicative of one or more events associated with a nomadic subculture.

For example, if the processing server 110 is identifying consumers 104 associated with a nomadic subculture for a musical group or artist, then the processing unit 204 may identify merchant identification numbers or category codes associated with venues on the group or artist's tour and may identify transaction dates and geographic locations associated with tour stops on the group or artist's tour. In another example, the processing unit 204 may identify merchant geographic locations and transaction periods of time corresponding to specific types of conventions.

Once event-indicative data values have been identified or received, then, in step 308, the processing unit 204 may identify a subset of transaction data entries 210 stored in the transaction database 208 where the included merchant data values include at least one of the one or more event-indicative merchant data values and the included transaction data values include at least one of the one or more event-indicative transaction data values. In step 310, the processing unit 204 may identify consumers 104 associated with the nomadic subculture by identifying consumer identifiers included in the identified subset transaction data entries 210.

In step 312, the processing unit 204 may determine if each identified consumer is identified as being involved in multiple nomadic subculture events. The determination may be based on if the corresponding consumer identifier is included in a transaction data entry 210 in the subset in more than one event based on the event-indicative data values. For example, a first consumer 104 involved in two payment transactions at the same geographic location and on the same date may have transacted twice during a single event and may not be involved in two different events, whereas a second consumer 104 involved in two payment transactions at two different geographic locations and on two different dates may be said to be involved in two different events.

If a consumer 104 is identified as not being involved in multiple events, then, in step 314, the processing unit 204 may update their related consumer profile 214 in the consumer database 212 to indicate that the related consumer 104 is not an influencer and/or not a member of the nomadic subculture. If the consumer 104 is identified as being in multiple events, then, in step 316, the processing unit 204 may update their related consumer profile 214 in the consumer database 212 to indicate that the consumer 104 is an influencer and/or a member of the nomadic subculture.

Once the consumers 104 involved in the transaction data entries 210 in the subset have been identified and their profiles updated, then, in step 318, the processing unit 204 may organize the consumers 104 that are identified as being influencers and/or members of the nomadic subculture based on their involvement in the nomadic subculture events. The organization may be based on a number of events attended, spending at or during the events, and any other additional criteria and/or combination thereof as will be apparent to persons having skill in the relevant art.

In step 320, the processing unit 204 may then identify key influencers in the nomadic subculture. The key influencers may be based on the organization of the consumers 104, and may be selected based on additional criteria. For example, the processing unit 204 may identify a predetermined number of the top consumers 104, a predetermined percentage of the top consumers 104, the top consumer 104 for each of multiple methods of organization, etc. In some embodiments, the processing unit 204 may update the consumer profiles 214 corresponding to the identified key influencers to indicate the related consumers 104 as being key influencers to the subculture.

### Exemplary Method for Identifying Influencers in Nomadic Subcultures

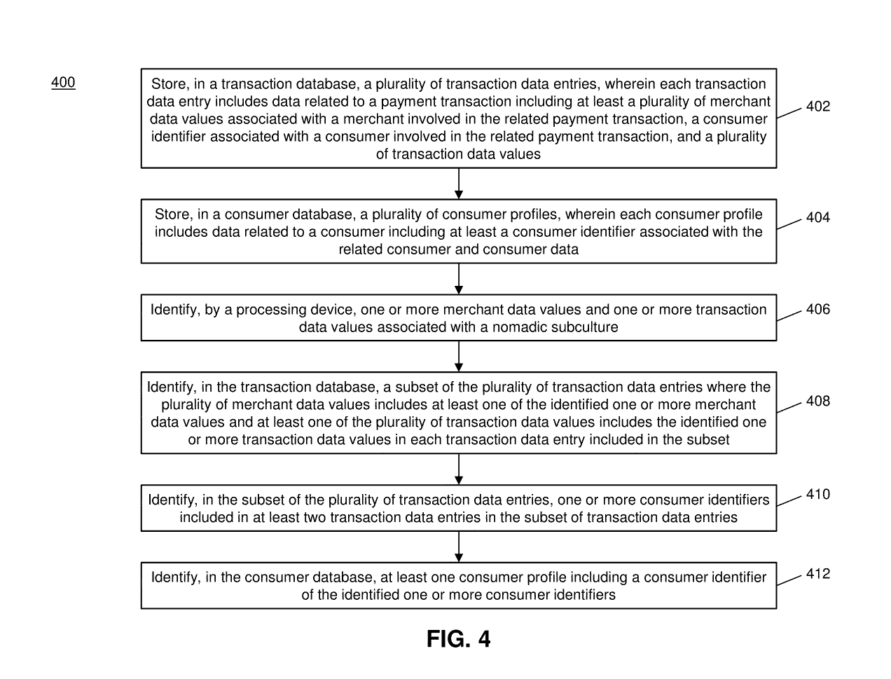

FIG. 4 illustrates a method 400 for identifying influencers in nomadic subcultures.

In step 402, a plurality of transaction data entries (e.g., transaction data entries 210) may be stored in a transaction database (e.g., the transaction database 208), wherein each transaction data entry 210 includes data related to a payment transaction including at least a plurality of merchant data values associated with a merchant (e.g., the merchant 106) involved in the related payment transaction, a consumer identifier associated with a consumer (e.g., the consumer 102) involved in the related payment transaction, and a plurality of transaction data values. In step 404, a plurality of consumer profiles (e.g., consumer profiles 214) may be stored in a consumer database (e.g., the consumer database 212), wherein each consumer profile 214 includes data related to a consumer 102 including at least a consumer identifier associated with the related consumer 102 and consumer data.

In step 406, one or more merchant data values and one or more transaction data values associated with a nomadic subculture may be identified by a processing device (e.g., the processing unit 204). In one embodiment, the one or more merchant values may include at least one of: a merchant name, merchant category, merchant industry, merchant category code, and merchant identification number. In some embodiments, the one or more transaction values may include at least one of: a product identifier, a product category, a geographic location, and time and/or date, and a transaction amount.

In step 408, a subset of the plurality of transaction data entries 210 may be identified in the transaction database 208 where the plurality of merchant data values includes at least one of the identified one or more merchant data values and at least one of the plurality of transaction data values includes the identified one or more transaction data values in each transaction data entry 210 included in the subset. In one embodiment, each of the transaction data entries 210 included in the subset may include a consumer identifier where a specific consumer profile 214 stored in the consumer database 212 includes the specific consumer identifier and includes consumer data corresponding to at least one of the one or more transaction data values. In a further embodiment, the at least one or more transaction data values may include a geographic location and the consumer data may include the geographic location or any location other than the geographic location.

In step 410, one or more consumer identifiers included in at least two transaction data entries 210 in the subset of transaction data entries may be identified. In step 412, at least one consumer profile 214 may be identified, in the consumer database 212, that includes a consumer identifier of the one or more consumer identifiers. In some embodiments, the at least one consumer profile 214 may be identified based on a number of transaction data entries 210 in the subset including the consumer identifier included in the at least one consumer profile 214. In one embodiment, the transaction data values included in each transaction data entry 210 may include at least a time and/or date for the related payment transaction, the at least one consumer profile 214 may be identified based on a frequency of transaction data entries 210 in the subset including the consumer identifier included in the at least one consumer profile 214, and the frequency of transaction data entries 210 may be based on the time and/or date included in each respective transaction data entry 210 in the subset including the consumer identifier included in the at least one consumer profile 214 and a number of transaction data entries 210 in the subset including the consumer identifier included in the at least one consumer profile 214.

In some embodiments, the method 400 may further include: receiving, by a receiving device (e.g., the receiving unit 202), wherein the request includes at least the one or more merchant data values and the one or more transaction data values; and transmitting, by a transmitting device (e.g., the transmitting unit 206), the identified at least one consumer profile 214 in response to the received request for influencers. In a further embodiment, the request for influencers may further include a predetermined number and identifying at least one consumer profile 214 may include identifying the predetermined number of consumer profiles 214 including a consumer identifier of the identified one or more consumer identifiers where the predetermined number of consumer profiles 214 is based on a number of transaction data entries 210 in the subset including the consumer identifier included in the respective consumer profile 214.

### Computer System Architecture

FIG. 5 illustrates a computer system 500 in which embodiments of the present disclosure, or portions thereof, may be implemented as computer-readable code. For example, the processing server 110 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

Techniques consistent with the present disclosure provide, among other features, systems and methods for identifying influencers in nomadic subcultures. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying influencers in nomadic subcultures, comprising:
storing, in a transaction database, a plurality of transaction data entries, wherein each transaction data entry includes data related to a payment transaction including at least a plurality of merchant data values associated with a merchant involved in the related payment transaction, a consumer identifier associated with a consumer involved in the related payment transaction, and a plurality of transaction data values;
storing, in a consumer database, a plurality of consumer profiles, wherein each consumer profile includes data related to a consumer including at least a consumer identifier associated with the related consumer and consumer data;
identifying, by a processing device, one or more merchant data values and one or more transaction data values associated with a nomadic subculture;
identifying, in the transaction database, a subset of the plurality of transaction data entries where the plurality of merchant data values includes at least one of the identified one or more merchant data values and at least one of the plurality of transaction data values includes the identified one or more transaction data values in each transaction data entry included in the subset;
identifying, in the subset of the plurality of transaction data entries, one or more consumer identifiers included in at least two transaction data entries in the subset of transaction data entries; and
identifying, in the consumer database, at least one consumer profile including a consumer identifier of the identified one or more consumer identifiers.

2. The method of claim 1, wherein each of the transaction data entries included in the subset includes a consumer identifier where a specific consumer profile stored in the consumer database includes the specific consumer identifier and includes consumer data corresponding to at least one of the one or more transaction data values.

3. The method of claim 2, wherein the at least one of the one or more transaction data values includes a geographic location and the consumer data includes the geographic location or any location other than the geographic location.

4. The method of claim 1, further comprising:
receiving, by a receiving device, a request for influencers, wherein the request includes at least the one or more merchant data values and the one or more transaction data values; and
transmitting, by a transmitting device, the identified at least one consumer profile in response to the received request for influencers.

5. The method of claim 4, wherein
the request for influencers further includes a predetermined number, and
identifying at least one consumer profile includes identifying the predetermined number of consumer profiles including a consumer identifier of the identified one or more consumer identifiers where the predetermined number of consumer profiles is based on a number of transaction data entries in the subset including the consumer identifier included in the respective consumer profile.

6. The method of claim 1, wherein the at least one consumer profile is identified based on a number of transaction data entries in the subset including the consumer identifier included in the at least one consumer profile.

7. The method of claim 1, wherein
the transaction data values included in each transaction data entry include at least a time and/or date for the related payment transaction,
the at least one consumer profile is identified based on a frequency of transaction data entries in the subset including the consumer identifier included in the at least one consumer profile,
the frequency of transaction data entries is based on the time and/or date included in each respective transaction data entry in the subset including the consumer identifier included in the at least one consumer profile and a number of transaction data entries in the subset including the consumer identifier included in the at least one consumer profile.

8. The method of claim 1, wherein the one or more merchant values includes at least one of: a merchant name, a merchant category, a merchant industry, a merchant category code, and a merchant identification number.

9. The method of claim 1, wherein the one or more transaction values includes at least one of: a product identifier, a product category, a geographic location, a time and/or date, and a transaction amount.

10. A system for identifying influencers in nomadic subcultures, comprising:
a transaction database configured to store a plurality of transaction data entries, wherein each transaction data entry includes data related to a payment transaction including at least a plurality of merchant data values associated with a merchant involved in the related payment transaction, a consumer identifier associated with a consumer involved in the related payment transaction, and a plurality of transaction data values;
a consumer database configured to store a plurality of consumer profiles, wherein each consumer profile includes data related to a consumer including at least a consumer identifier associated with the related consumer and consumer data; and
a processing device configured to
identify one or more merchant data values and one or more transaction data values associated with a nomadic subculture,
identify, in the transaction database, a subset of the plurality of transaction data entries where the plurality of merchant data values includes at least one of the identified one or more merchant data values and at least one of the plurality of transaction data values includes the identified one or more transaction data values in each transaction data entry included in the subset,
identify, in the subset of the plurality of transaction data entries, one or more consumer identifiers included in at least two transaction data entries in the subset of transaction data entries, and
identify, in the consumer database, at least one consumer profile including a consumer identifier of the identified one or more consumer identifiers.

11. The system of claim 10, wherein each of the transaction data entries included in the subset includes a consumer identifier where a specific consumer profile stored in the consumer database includes the specific consumer identifier and includes consumer data corresponding to at least one of the one or more transaction data values.

12. The system of claim 11, wherein the at least one of the one or more transaction data values includes a geographic location and the consumer data includes the geographic location or any location other than the geographic location.

13. The system of claim 10, further comprising:
a receiving device configured to receive a request for influencers, wherein the request includes at least the one or more merchant data values and the one or more transaction data values; and
a transmitting device configured to transmit the identified at least one consumer profile in response to the received request for influencers.

14. The system of claim 13, wherein
the request for influencers further includes a predetermined number, and
identifying at least one consumer profile includes identifying the predetermined number of consumer profiles including a consumer identifier of the identified one or more consumer identifiers where the predetermined number of consumer profiles is based on a number of transaction data entries in the subset including the consumer identifier included in the respective consumer profile.

15. The system of claim 10, wherein the at least one consumer profile is identified based on a number of transaction data entries in the subset including the consumer identifier included in the at least one consumer profile.

16. The system of claim 10, wherein
the transaction data values included in each transaction data entry include at least a time and/or date for the related payment transaction,
the at least one consumer profile is identified based on a frequency of transaction data entries in the subset including the consumer identifier included in the at least one consumer profile,
the frequency of transaction data entries is based on the time and/or date included in each respective transaction data entry in the subset including the consumer identifier included in the at least one consumer profile and a number of transaction data entries in the subset including the consumer identifier included in the at least one consumer profile.

17. The system of claim 10, wherein the one or more merchant values includes at least one of: a merchant name, a merchant category, a merchant industry, a merchant category code, and a merchant identification number.

18. The system of claim 10, wherein the one or more transaction values includes at least one of: a product identifier, a product category, a geographic location, a time and/or date, and a transaction amount.
